(19) United States
(12) Patent Application Publication
(10) Pub. No.: US 2026/0103043 A1
(43) Pub. Date: Apr. 16, 2026

(54) VEHICLES, METHODS AND ASSEMBLIES FOR VEHICLES

(71) Applicant: Ford Global Technologies, LLC, Dearborn, MI (US)

(72) Inventors: Gerhard Friederich, Bornheim (DE); Alexander Ein Waldt, Köln (DE); Sergio Codonesu, Aachen (DE); Oliver Nehls, Düsseldorf (DE); Goetz-Philipp Wegner, Dortmund (DE)

(21) Appl. No.: 19/348,186

(22) Filed: Oct. 2, 2025

(30) Foreign Application Priority Data
Oct. 10, 2024 (DE) 102024129352.7

(51) Int. Cl. B60H 1/00; B62D 5/00

(52) U.S. Cl. CPC B60H 1/00271; B60H 2001/00307; B62D 5/001

(57) ABSTRACT

A disclosed example assembly to be installed in a powered motor vehicle, the assembly includes: a climate control system having a climate control circuit; and a steer-by-wire steering system having a road wheel actuator, wherein: a climate control medium circulates in the climate control circuit; the steer-by-wire steering system is coupled to the climate control system; and the climate control medium is applied at least indirectly to the road wheel actuator to cool and heat the road wheel actuator.

### RELATED APPLICATION

This patent claims priority from DE Patent Application Number 102024129352.7, which was filed on Oct. 10, 2024, and is hereby incorporated herein by reference in its entirety.

### FIELD OF THE DISCLOSURE

The disclosure relates in general to assemblies for powered motor vehicles, methods for operating assemblies and motor vehicles.

### BACKGROUND

Steer-by-wire (SBW) steering systems are a steering technology in which the direct mechanical connection between the steering wheel and the road wheel is omitted. This direct connection is replaced by two actuators: a steering wheel actuator with feedback which generates a feedback torque for the driver at the steering wheel, and a road wheel actuator which controls at least one but typically multiple steerable road wheels into the desired position. The feedback torque provides the driver with a feeling about the lateral movement of the motor vehicle.

### SUMMARY

Example methods, apparatus, systems, and articles of manufacture to assemblies for vehicles, methods and vehicles are disclosed herein. Further examples and combinations thereof include the following:

Example 1 includes an assembly to be installed in a vehicle, the assembly comprising a climate control system having a climate control circuit, and a steer-by-wire steering system having a road wheel actuator, wherein a climate control medium circulates in the climate control circuit, the steer-by-wire steering system is coupled to the climate control system, and the climate control medium is applied at least indirectly to the road wheel actuator to cool and heat the road wheel actuator.

Example 2 includes the assembly of any preceding clause of Example 1, wherein the road wheel actuator has an integrated cooling medium chamber through which the climate control medium is to flow.

Example 3 includes the assembly of any preceding clause of any one or more of Examples 1-2, wherein the integrated cooling medium chamber is coupled to a drive unit of the road wheel actuator.

Example 4 includes the assembly of any preceding clause of any one or more of Examples 1-3, wherein the road wheel actuator includes a heat exchanger, the heat exchanger coupled at least indirectly to an electric motor and to a converter of the road wheel actuator and through which the climate control medium is to flow.

Example 5 includes the assembly of any preceding clause of any one or more of Examples 1-4, including a temperature controller device, wherein the temperature controller device is configured to trigger an at least indirect application of the climate control medium to the road wheel actuator.

Example 6 includes the assembly of any preceding clause of any one or more of Examples 1-5, including a temperature sensor coupled to the road wheel actuator, and an ambient temperature sensor, wherein the temperature controller device is to trigger the at least indirect application of the climate control medium to the road wheel actuator at least also based on a temperature of the road wheel actuator recorded based on the temperature sensor and an ambient temperature recorded based on the ambient temperature sensor.

Example 7 includes the assembly of any preceding clause of any one or more of Examples 1-6, wherein the temperature controller device is configured to trigger the at least indirect application of the climate control medium to the road wheel actuator to perform preheating for an intended use of the vehicle.

Example 8 includes the assembly of any preceding clause of any one or more of Examples 1-7, wherein the temperature controller device is to trigger the at least indirect application of the climate control medium to the road wheel actuator to perform preheating based on detection of a key approaching the vehicle.

Example 9 includes a method to operate an assembly of a vehicle, the method comprising circulating a climate control medium in a climate control circuit of a climate control system corresponding to a steer-by-wire system of the assembly, and applying the climate control medium at least indirectly to a road wheel actuator of the climate control system to cool and heat the road wheel actuator.

Example 10 includes the method of any preceding clause of Example 9, including circulating the climate control medium through an integrated cooling medium chamber of the road wheel actuator.

Example 11 includes the method of any preceding clause of any one or more of Examples 9-10, wherein the integrated cooling medium chamber is coupled to a drive unit of the road wheel actuator.

Example 12 includes the method of any preceding clause of any one or more of Examples 9-11, including circulating the climate control medium through a heat exchanger of the road wheel actuator, the heat exchanger coupled at least indirectly to an electric motor and to a converter of the road wheel actuator.

Example 13 includes the method of any preceding clause of any one or more of Examples 9-12, including triggering an application of the climate control medium to the road wheel actuator to perform preheating for an intended use of the vehicle.

Example 14 includes the method of any preceding clause of any one or more of Examples 9-13, wherein the triggering of the application of the climate control medium to the road wheel actuator to perform the preheating is based on detection of a driver entering the vehicle.

Example 15 includes a motor vehicle comprising a climate control system having a climate control circuit, a steer-by-wire system having a road wheel actuator, the steer-by-wire system coupled to the climate control system, and a climate control medium to circulate in the climate control circuit to cool and heat the road wheel actuator.

Example 16 includes the motor vehicle of any preceding clause of Example 15, wherein the road wheel actuator has an integrated cooling medium chamber coupled to a drive unit of the road wheel actuator, the integrated cooling medium chamber to receive the climate control medium.

Example 17 includes the motor vehicle of any preceding clause of any one or more of Examples 15-16, wherein the climate control circuit comprises at least one of a high-voltage storage circuit, a passenger compartment circuit or a drive unit circuit of the motor vehicle.

Example 18 includes the motor vehicle of any preceding clause of any one or more of Examples 15-17, including a temperature sensor coupled to the road wheel actuator, an ambient temperature sensor, and a temperature controller device to trigger application of the climate control medium to the road wheel actuator at least also based on a temperature of the road wheel actuator recorded based on the temperature sensor and an ambient temperature recorded based on the ambient temperature sensor.

Example 19 includes the motor vehicle of any preceding clause of any one or more of Examples 15-18, including a temperature controller device to trigger application of the climate control medium to the road wheel actuator to perform preheating for an intended use of the motor vehicle.

Example 20 includes the motor vehicle of any preceding clause of any one or more of Examples 15-19, wherein the temperature controller device is to trigger the application of the climate control medium to the road wheel actuator to perform the preheating based on detection of a key approaching the motor vehicle.

### BRIEF DESCRIPTION OF THE DRAWINGS

The disclosure and also other advantageous examples and developments thereof are further described and explained below in connection with examples illustrated in the drawings.

FIG. 1 shows an example schematic representation of an example motor vehicle with an assembly in accordance with teachings of this disclosure.

FIG. 2 to FIG. 4 show example schematic representations of example road wheel actuators that may be implemented in the assembly of FIG. 1 in accordance with teachings of this disclosure.

FIG. 5 is a flowchart representative of example machine-readable instructions and/or example operations that may be executed, instantiated, and/or performed by example programmable circuitry to implement the assembly of FIG. 1 for a powered motor vehicle in accordance with teachings of this disclosure.

FIG. 6 to FIG. 11 show example schematic representations of the assembly of FIG. 1 in accordance with teachings of this disclosure.

FIG. 12 is a block diagram of an example processing platform including programmable circuitry structured to execute, instantiate, and/or perform the example machine-readable instructions and/or perform the example operations of FIG. 5 to implement the assembly of FIG. 1.

The detailed description below in conjunction with the attached drawings in which identical numerals refer to identical elements is intended as a description of different examples of the disclosed subject matter and is not intended to represent the sole examples. Each example described in the disclosure serves solely as an example or illustration and should not be interpreted as preferred or advantageous over other examples. The illustrative examples contained herein do not claim to be exhaustive and do not limit the claimed subject matter to the exact forms disclosed. Different modifications of the examples described are readily apparent to those skilled in the art, and the general principles defined herein may be applied to other examples and applications without departing from the spirit and scope of the examples described. Therefore, the examples described are not limited to the examples shown, but have the broadest possible scope of application consistent with the principles and features disclosed herein.

### DETAILED DESCRIPTION

Due to the mechanical decoupling of the steering wheel from the road wheel actuator, the driver is eliminated as the source of mechanical input power for steering. Accordingly, the road wheel actuator is configured to generate the torque necessary to steer the steerable road wheels of a vehicle. In so doing, it is to be taken into consideration that, due to the variable, very direct translation function of the SBW steering system in comparison to conventional electrically supported servo-steering systems, it is necessary for the road wheel actuator to support considerably faster wheel movements. This can lead to high performance requirements for the road wheel actuator in specific operating situations, for example during parking or reversing maneuvers which require a lot of maneuvering, when towing loads, when driving off-road, when racing, or in the case of special ground conditions which cause high slip. In these situations, a significant amount of heat can therefore be generated in the road wheel actuator.

In the field of electrically supported servo-steering systems, one strategy to counteract excessive heat generation involves deliberately reducing the power of the road wheel actuator, thereby limiting or even reducing the amount of generated heat. However, a reduction in the available road wheel actuator power leads to a deterioration in the lateral control of the motor vehicle and can cause unexpected operating conditions in the lateral control of the motor vehicle, for example unexpected operating conditions with respect to individual components of the SBW steering system. This can ultimately cause loss of steerability.

Whereas these aspects relate to deterioration in performance and unexpected operating conditions when the road wheel actuator heats up, low temperatures also lead to unexpected operating conditions. Transmission components such as belts or worm gears are produced from elastomers and synthetic materials, for example rubber and glass fiber structures for belts and resin or synthetic material for worm gears. These materials can lose their integrity and ability to transmit force if they are exposed to extreme temperatures which are lower than the glazing temperature of the material. Very low temperatures can lead to embrittlement and unexpected operating conditions. As a result, sudden loss of function can occur during the regular operation. Unexpected operating conditions of the SBW steering system up to loss of steerability can result from the components being a part of the force transmission path.

In examples disclosed herein, “unexpected operating condition” refers to a condition or a state of a component that is unavailable, inoperable, and/or operating outside of an operating specification performance range of the component.

JP 2004-314736 A discloses an SBW steering system, in which a Peltier element is provided for cooling the road wheel actuator. JP 2005-319932 A discloses a steering system, in which a Peltier element is used for controlling the temperature of a servo-steering liquid. However, the Peltier element causes a high loss of power resulting in a reduction in the range of electrically powered motor vehicles.

Examples disclosed herein eliminate or at least reduce the disadvantages of known assemblies and steering systems in light of heat generation and/or external temperatures. Examples disclosed herein optimize the efficiency of an SBW steering system with respect to the road wheel actuator for a wide as possible range of thermal conditions.

Examples disclosed herein are represented in the independent claims, the dependent claims and the description below, each of which may represent aspects of the disclosure individually or in (sub-) combination. Some features are explained with respect to a method, others with respect to assemblies. However, the corresponding aspects are to be transferred reciprocally in an appropriate manner.

According to one aspect, some examples of the disclosure relate to an assembly for a powered motor vehicle. The assembly comprises at least one climate control system with at least one climate control circuit and a SBW steering system with at least one road wheel actuator. At least one climate control medium circulates in the climate control circuit. The SBW steering system is coupled to the climate control system in such a manner that the climate control medium can be applied at least indirectly to the at least one road wheel actuator for temperature control purposes.

The disclosure is based on the knowledge that a relatively uniform temperature control of the road wheel actuator can be ensured by virtue of the fact that the SBW steering system is coupled to a climate control system of the motor vehicle. As a result, in some examples, a circulating climate control medium may be used to reduce or compensate for the effects of both particularly low temperatures and also excessively high temperatures, which can be caused, for example, by high load conditions imposed by the road wheel actuator. As a result, the temperature of the road wheel actuator can be maintained uniform in comparison to approaches used to-date, as a result of which the functional capability of the road wheel actuator can be ensured over a wide temperature range. In addition, the efficiency of the road wheel actuator is also maintained relatively constant over a wide temperature range, as a result of which the design of the SBW steering system is simplified with respect to the lateral control of the motor vehicle.

Furthermore, it is thus ensured that the frequency of unexpected operating conditions, for example due to temperature-related influences on components of the SBW steering system, is reduced. By way of example, examples disclosed herein may be used to prevent components based on synthetic material or elastomer from becoming brittle due to low ambient temperatures. Overall, the serviceable life of the SBW steering system can thus be extended, at least with respect to the road wheel actuator. In addition, the comfort for the driver of the motor vehicle can also be increased, because the steering behavior is designed more uniformly than before with regard to the lateral control of the motor vehicle. Additionally, the coupling to the climate control system renders it possible to design the hitherto provided cooling components of the road wheel actuator smaller or to replace them. As a result, installation space and weight can be reduced. Controlling the temperature of the road wheel actuator may be used to also prevent, for example, that during long straight-line journeys in the case of low ambient temperatures, in which the road wheel actuator is not in use, the road wheel actuator may freeze. Otherwise, freezing can be caused by freezing condensation, for example.

In accordance with a further aspect, some examples of the disclosure relate to a method for operating an assembly for a powered motor vehicle. The assembly comprises at least one climate control system with at least one climate control circuit and an SBW steering system which is coupled to the climate control system and has at least one road wheel actuator. At least one climate control medium circulates in the climate control circuit. The method comprises the following operations: the climate control medium is applied at least indirectly to at least the road wheel actuator for temperature control purposes.

The advantages which can be achieved by the assembly described herein are also achieved in a corresponding manner by the method.

The term “at least indirectly” is to be understood to mean that even more mechanical components can be arranged between the climate control medium and the road wheel actuator or rather components thereof. For example, the climate control medium can be solely in contact with an outer housing of the road wheel actuator, which in turn is then in thermal contact through heat conduction or heat radiation with further components of the road wheel actuator, for example the electric motor, a converter (a drive unit) and/or force transmission components. Nevertheless, the thermal contact between the climate control medium and the road wheel actuator is such that the temperature of the road wheel actuator is influenced by the climate control medium in a lasting, e.g., non-negligible, manner.

In some examples, the climate control medium can also be applied directly to the road wheel actuator for temperature control purposes. As a result the heat conduction path is optimized.

The term “SBW steering system of the motor vehicle” is understood to mean here the conventional SBW steering system of the motor vehicle but not an auxiliary steering system that is only made possible by controlling the torque with respect to drive units and/or deceleration devices (e.g., wheel brakes) assigned to respective road wheels, e.g., not a TLC (so called tertiary lateral control or a TLC (“tertiary lateral control”)). In this context, the term “drive units” is to be understood here to mean powered electric motors which are each assigned to at least one road wheel and serve to drive the motor vehicle, but not (primarily) the vehicle lateral control. On the contrary, the drive units of the TLC are separate to the road wheel actuators and their electric motors.

The SBW steering system has at least one road wheel actuator which is coupled to the at least one steerable road wheel. In some examples, the road wheel actuator can also be coupled simultaneously at least indirectly to multiple steerable road wheels, for example via a toothed rack.

Alternatively or additionally, the motor vehicle can have multiple road wheel actuators which are each coupled individually to multiple steerable road wheels. As a result, the variability of the SBW steering system is increased.

In accordance with a further alternative, the motor vehicle can also have separate individual road wheel actuators with respect to at least some steerable road wheels of the motor vehicle. As a result, the relevant steerable road wheels can be controlled independently from other steerable road wheels for the lateral control of the motor vehicle according to individual wheel orientations. Accordingly, for example, individual steerable road wheels may have different orientations, for example, a toe-in position or toe-out position with respect to a track position defined by the steering wheel angle of the steering wheel. This means that the relevant steerable road wheels intentionally diverge from the track position which actually corresponds to the steering command from the driver and/or the path tracking functional capability. This can be advantageous, for example, if individual road wheels of the motor vehicle exhibit high slip, for example due to the nature of the ground (when driving off-road or similar conditions).

If the SBW steering system has multiple road wheel actuators, the road wheel actuators can be coupled together to the climate control system in a corresponding manner. Accordingly, examples disclosed herein may be used to ensure an at least indirect control of the temperature of the respective road wheel actuator based on the climate control medium for each road wheel actuator.

In some examples, the lateral control of the motor vehicle can be based at least in part on steering commands from the driver, which the driver issues, for example, using the steering wheel to steer the motor vehicle in a specific direction.

Naturally, the SBW steering system can have further components usually provided, such as a steering wheel actuator, a steering wheel sensor and others.

The climate control system can have further standard components of climate control systems, for example, pumps, lines, valves, atomizers, heat exchangers, cooling media containers (cooling media reservoirs), and others.

In some examples, the climate control medium comprises a cooling liquid, for example water. The cooling liquid can also have additives. The additives can, for example, prevent the cooling liquid freezing at low ambient temperatures. The additives may comprise minerals or salts. Other cooling liquids may additionally or alternatively be used. As a result, examples disclosed herein may use a wide range of different climate control media which are also designed for different external conditions.

In some examples, the temperature of the road wheel actuator can be maintained constant within a predetermined temperature range due to the climate control medium being applied at least indirectly, irrespective of the ambient temperatures or the load state of the road wheel actuator. Naturally, maintaining a constant temperature relates here to the operating state in which the climate control medium also actually circulates and not to a state in which it is arranged solely in the corresponding climate control circuit without circulating. Accordingly, examples disclosed herein may be used to ensure defined operating conditions for the road wheel actuator.

In some examples, the road wheel actuator has an integrated cooling medium chamber which the climate control medium can flow through. As a result, examples disclosed herein may be used to control the temperature of a defined region of the road wheel actuator which is in contact with the cooling medium chamber. For example, heat develops within the road wheel actuator during the operation with regard to specific components of the road wheel actuator. The cooling medium chamber can then either be arranged in direct contact with these components or as close as possible to these components so that the heat conduction paths are particularly short. It is thus efficiently ensured that heat is dissipated from the road wheel actuator.

In a further alternative, the cooling medium chamber can be coupled, for example, in a simple manner to the housing of the road wheel actuator. As a result, it is not necessary to make modifications to the internal layout and the arrangement of the internal components of the road wheel actuator. Thus, the outlay for the assembly is particularly low.

In an additional alternative, the road wheel actuator can even be retrofitted through the cooling medium chamber. The cooling medium chamber can then be attached on an outer side of the housing to the housing of the road wheel actuator. Accordingly, examples disclosed herein may be used to ensure that the temperature of the road wheel actuator is controlled even in the case of existing SBW steering systems, whereby their functional capability is considerably increased.

In some examples, the integrated cooling medium chamber is coupled at least to one drive unit of the road wheel actuator. Significant amounts of heat develop in the drive unit if the road wheel actuator has to deliver high performances for the lateral control of the motor vehicle. These amounts of heat can be transported away efficiently as a result of coupling the cooling medium chamber to the drive unit. The drive unit can comprise a converter and the electric motor of the road wheel actuator. In this context, the climate control medium can naturally not only cool but also heat the road wheel actuator or components thereof depending upon the temperature of the climate control medium in the climate control circuit and in relation to the ambient temperature. As already explained above, examples disclosed herein may be used, for example, to prevent components containing synthetic material or elastomers from becoming brittle.

In some examples, the road wheel actuator can have a force transmission unit. The force transmission unit of the road wheel actuator typically has multiple force transmission devices which comprise synthetic materials and/or elastomers. In accordance with this example, the cooling medium chamber is not directly coupled to the force transmission unit. However, the force transmission unit and its components profit indirectly therefrom that the temperature of the road wheel actuator is maintained more uniformly constant than before. Thus, the components of the force transmission unit can be protected from unexpected operating conditions which are caused based on low ambient temperatures.

In some examples, the road wheel actuator has a heat exchanger through which the climate control medium can flow and which is coupled at least indirectly to an electric motor and an electronic power unit of the road wheel actuator. The heat exchanger may be used to ensure the transmission of heat starting from the road wheel actuator to the climate control medium or conversely in a defined manner. During the operation of the road wheel actuator, the indirect coupling of the heat exchanger to these components leads to an efficient temperature control of the road wheel actuator because heat is mainly generated with regard to the electric motor and the electronic power unit.

The term “at least indirectly” is understood to mean here in turn that further components, for example a housing, can be arranged between the electric motor and the electronic power unit and also the heat exchanger. Nonetheless, the arrangement of the heat exchanger is such that efficient heat conduction between the electric motor, the electronic power unit and the heat exchanger is ensured.

In some examples, the heat exchanger can also be in direct contact with the electric motor and/or the electronic power unit. As a result the heat conduction path is optimized.

In some examples, the at least one climate control circuit comprises at least one of a high-voltage storage circuit, a passenger compartment circuit, and a drive unit circuit of the motor vehicle. Nowadays, motor vehicles typically have multiple climate control circuits. Powered motor vehicles have the mentioned climate control circuits because on the one hand the passenger compartment and on the other hand both the drive unit and the high-voltage storage device are to be temperature-controlled to ensure the respective functional capabilities and increase the comfort for the user of the motor vehicle. The assembly can now provide a coupling of the SBW steering system to the climate control system of the motor vehicle in such a manner that the road wheel actuator is combined and coupled with respect to its temperature control in a simple manner to an existing climate control circuit. This means that the road wheel actuator is taken into consideration with respect to at least one climate control circuit merely as additional components within the climate control circuit. As a result, the construction outlay for the design of the assembly is low, because it is not necessary to implement a complete additional climate control circuit in the motor vehicle. In addition, this provides the opportunity to retrofit existing motor vehicles by adapting at least one of the mentioned climate control circuits to control the temperature of the road wheel actuator.

In some examples, the assembly also has at least one temperature controller device. The temperature controller device is configured to trigger an at least indirect application of the climate medium to the road wheel actuator. This means that the temperature controller device controls at least part of the climate control circuit. For example, the temperature controller device can control pumps, valves, heat exchangers or distribution devices, such as for example nozzles, of the climate control circuit. To control the temperature control of the road wheel actuator and/or further components of the corresponding climate control circuit, the temperature controller device can output corresponding control signals to components of the climate control circuit so that the circulation of the climate control medium is triggered or controlled in a manner appropriate to requirements.

The temperature controller device can be used to determine a heat dissipation capacity tailored to the load condition of the road wheel actuator. The load state of the road wheel actuator refers, for example, to the energy consumption (electrical energy) required to exert the requested lateral control torques. For example, an average value can be determined for the load state per unit of time. This allows peak performances to be balanced out, but it is still possible to reliably determine whether the road wheel actuator is subject to high performance requirements, which typically results in a temperature increase. On the basis of the load state, examples disclosed herein may use the temperature controller device to estimate how much energy needs to be dissipated from the road wheel actuator. Taking into account known parameters of the climate control circuit, examples disclosed herein may estimate the necessary pump capacity of a pump of the climate control circuit required to handle the heat dissipation capacity.

In some examples, the assembly also has at least one temperature sensor, which is coupled to the road wheel actuator, and an ambient temperature sensor. The temperature controller device is configured to trigger the at least indirect application of the climate control medium to the road wheel actuator at least also based on a temperature of the road wheel actuator recorded by the temperature sensor and an ambient temperature recorded by the ambient temperature sensor. This allows the initiation and influencing of the climate control cycle with regard to the circulation of the climate control medium to be adapted to the prevailing temperature conditions with respect to the road wheel actuator and the environment of the motor vehicle in a manner appropriate to requirements. Accordingly, examples disclosed herein may, for example, use the temperature controller device to determine that the temperature of the road wheel actuator increases, for example, due to the load state. As a result, the temperature controller device can modify the circulation of the climate control medium, for example an increased through-flow rate of the climate control medium per unit of time, whereby the cooling capacity with respect to the heat dissipation from the road wheel actuator is increased based on the climate control medium and adapted with respect to the temperature increase of the road wheel actuator. As a result, examples disclosed herein may be used to ensure that the temperature increase of the road wheel actuator is weakened or compensated so that ultimately a temperature reduction of the road wheel actuator can be achieved.

The temperature sensor, which is coupled to the road wheel actuator, and the ambient temperature sensor can be used by the temperature controller device to determine a cooling capacity tailored to the load state of the road wheel actuator. The cooling capacity can thus be estimated in such a manner that the temperature of the road wheel actuator remains constant within a predetermined temperature interval. If the parameters of the climate control circuit are known, examples disclosed herein may be used to determine the necessary pump capacity required to be able to provide the cooling capacity.

The temperature controller device can directly or at least indirectly control devices of the climate control circuit. For this purpose, the temperature controller device can output corresponding control signals. The control signals are determined, for example, using the cooling capacity and/or the heat dissipation capacity.

In some examples, the ambient temperature sensor may be used to also detect, for example, that the ambient temperature is particularly low. In such examples, the temperature controller device can trigger a temperature control, e.g., a temperature increase, of at least some components of the road wheel actuator or of the road wheel actuator as a whole to prevent unexpected operating conditions with regard to the road wheel actuator and its components.

In some examples, the temperature controller device is configured to trigger the at least indirect application of the climate control medium to the road wheel actuator as preheating for an intended use of the motor vehicle. This means that the temperature controller device can be coupled to further components of motor vehicle to be able to determine that the motor vehicle is to be used by a user of the motor vehicle within a forthcoming period of time. For this purpose, the temperature controller device can be coupled, for example, to environmental sensors of the motor vehicle, to a position signal receiver, to a communication device, to a charge controller, to a battery management unit and/or to an interior compartment sensor of the motor vehicle. As soon as the temperature controller device determines that the motor vehicle is to be used soon by a user, the temperature controller device can determine on the basis of the ambient temperature recorded by the ambient temperature sensor whether it is necessary to preheat the road wheel actuator to prevent unexpected operating conditions. If the ambient temperature is below an ambient temperature threshold value, the preheating can be triggered. The temperature controller device controls the climate control circuit in an appropriate manner to cause the climate control medium to circulate, whereby the road wheel actuator is temperature controlled and preheated.

The preheating can be triggered, for example by the temperature controller device to the extent that the temperature controller device determines that a driver of the motor vehicle enters the motor vehicle. For this purpose, the temperature controller device can use environmental data recorded by an environmental sensor or interior data recorded by an interior compartment sensor. In addition, based on an opening of the driver door, examples disclosed herein may detect the entry of the driver. Furthermore, the entry of the driver can also be recognized by the fact that the vehicle key is identified as being initially outside the motor vehicle and subsequently inside the motor vehicle by the communication device.

An intended journey with the motor vehicle can also be determined by the temperature controller device on the basis that the driver transmits a destination to the motor vehicle or via a user interface.

In addition, the temperature controller device can also determine whether preheating is necessary based on whether the motor vehicle is charged. For example, for this purpose, the temperature controller device can receive relevant information from the charge controller or the battery management unit.

In a special example, the preheating can always be triggered if the motor vehicle is being charged.

In a further example, the triggering of the preheating can depend upon whether the high-voltage storage device of the (electrically powered) motor vehicle is warmed up or heated. To ensure the functional capability of at least in part electrically powered motor vehicles, mechanisms are already known to heat up or to heat the high-voltage storage device, for example if low ambient temperatures prevail. This can be exploited to be used by the temperature controller device as a triggering event with respect to a required preheating of the road wheel actuator. The temperature controller device can receive the relevant information regarding heating or warming the high-voltage storage device from a charge controller or the battery management unit, for example.

In some examples, the method is configured as a computer-implemented method. This means that operations of the method can be performed using one or more data processing devices. For example, a data processing device of the temperature controller device can trigger or perform the relevant operations.

In accordance with a further aspect, the disclosure also relates to a computer program product comprising commands which, when the program is executed by a computer, cause the computer to perform the method described herein. The advantages which can be achieved by the method described herein are also achieved in a corresponding manner by the computer program product.

In accordance with a further aspect, the disclosure also relates to a computer-readable storage medium comprising commands which, when the program is executed by a computer, cause the computer to perform the method described herein. The advantages which can be achieved by the method described herein are also achieved in a corresponding manner by the computer-readable storage medium.

In accordance with a further aspect, the disclosure also relates to a motor vehicle with an assembly as described herein or an assembly which can be operated according to the method as described herein.

In examples disclosed herein, motor vehicles can include land vehicles, namely among other things, off-road and road vehicles such as passenger cars, buses, trucks, and other commercial vehicles. Motor vehicles can be manned or unmanned. The motor vehicles are electrically powered, at least in part electrically powered or can also include motor vehicles with combustion engines which are used for propulsion.

All features explained with respect to the different aspects can be combined individually or in (sub-) combination with other aspects.

All features disclosed below with reference to the examples and/or accompanying figures may be combined alone or in any sub-combination with features of the aspects of the disclosure, including features of preferred examples, provided that the resulting combination of features is meaningful to a person skilled in the art in the field of technology.

For the purposes of disclosure, the phrase “at least one of A, B, and C” means, for example, (A), (B), (C), (A and B), (A and C), (B and C), or (A, B, and C), including all other possible combinations when more than three elements are listed. In other words, the term “at least one of A and B” generally means “A and/or B,” namely “A” alone, “B” alone, or “A and B.”

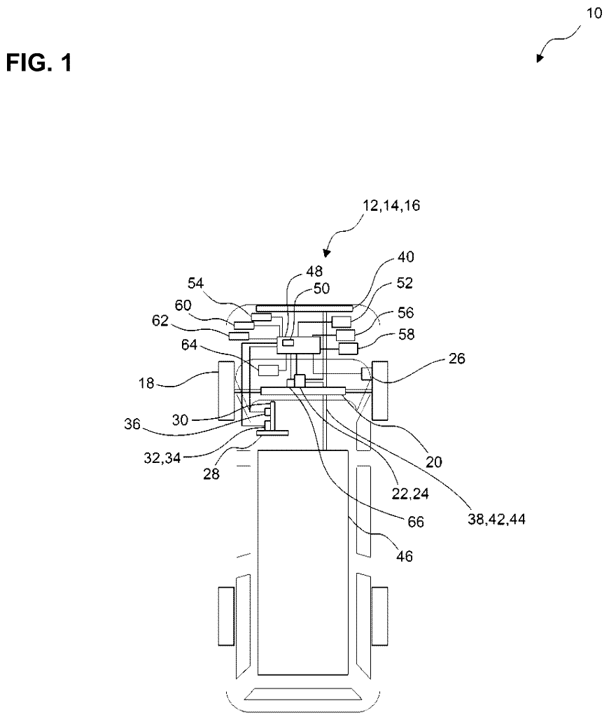

FIG. 1 shows a simplified schematic representation of a motor vehicle 10 with an assembly 12 in accordance with examples disclosed herein.

The assembly 12 comprises at least one SBW steering system 14 and a climate control system 16 of the motor vehicle 10.

The SBW steering system 14 has steerable road wheels 18. The steerable road wheels 18 are coupled to a common toothed rack 20. The common toothed rack 20 can be moved out of a reference position, for example a zero position, which produces a steering movement of the steerable road wheels 18. The steerable road wheels 18 can thus be deflected, for example, starting from a straight line orientation of the motor vehicle 10, so that the motor vehicle 10 performs a curve maneuver.

To move the toothed rack 20, the SBW steering system 14 in accordance with some examples has an individual road wheel actuator 22 which in such examples can jointly influence the orientation of both steerable road wheels 18 (front wheels) of the motor vehicle 10. In the present case, the road wheel actuator 22 is coupled to the toothed rack 20. Alternatively, the road wheel actuator 22 can also be coupled in a different manner to the steerable road wheels 18 to be able to influence their orientation.

In an alternative example, it is also possible to provide multiple road wheel actuators 22 which are each coupled individually to a steerable road wheel 18. This has the advantage that the road wheels 18 are not jointly moved, as a result of which the road wheels 18 can be oriented individually. For example, individual road wheels 18 can assume dedicated outer track positions, for example for specific driving situations (off-road journeys). The term “outer track position” is intended to mean here that the road wheels 18 are not oriented according to the nominal track position which is defined by the steering command from the driver.

Even when not represented in the example shown in FIG. 1, the motor vehicle 10 can have the assembly 12 and the SBW steering system 14, and also further steerable road wheels 18, for example rear wheels, which are coupled to an additional common or individual road wheel actuators 22.

Each road wheel actuator 22 has an electric motor 24. The electric motor 24 has at least one winding set which comprises a group of windings. Each winding set is configured so that, when supply signals such as phase voltages are applied, phase currents are established in the underlying windings which can be used to drive a rotor of the electric motor 24. The rotor can then be coupled to a corresponding component of the SBW steering system 14, for example of the toothed rack 20, and accordingly cause the steerable road wheels 18 to move.

In general, the electric motor 24 can also have more than one winding set.

Typically, each winding set is three phase, so that the electric motor 24 is configured overall at least as a three phase motor, and, in some examples, a six phase motor or a nine phase motor.

If multiple winding sets are provided, the winding sets in each case cause the rotor of the electric motor 24 to move independent of other winding sets. This means that the winding sets are separate from one other.

In general, the assembly 12 comprises multiple wheel sensors 26, for example rotational wheel sensors, which are each allocated individually one road wheel 18. In some examples, the wheel sensors 26 may be used to record the rotational speeds of the road wheels 18 in the circumferential direction (rotation direction) individually. In some examples, the recorded rotational speeds may be used, for example to determine the individual wheel slip.

The SBW steering system 14 of the motor vehicle 10 also has a steering wheel 28. Using the steering wheel 28, a driver of the motor vehicle 10 can provide steering commands for the motor vehicle 10 to steer the motor vehicle 10 in a desired direction.

The steering wheel 28 is coupled to a steering column 30 of the SBW steering system 14. The steering column 30 defines the axis of rotation about which the steering wheel 28 can rotate.

A steering wheel actuator 32 of the SBW steering system 14 is coupled to the steering wheel 28. The steering wheel actuator 32 has a further electric motor 34. The electric motor 34 of the steering wheel actuator 32 likewise comprises at least one winding set. Each winding set of the electric motor 34 is three phase and configured to drive a rotor of the electric motor 34. As a result, in some examples, a feedback torque for the driver by the electric motor 34 may be provided at the steering wheel 28 of the motor vehicle 10, to provide the driver with a feeling regarding the lateral control of the motor vehicle 10.

The SBW steering system 14 has in addition at least one steering wheel sensor 36 which is coupled to the steering wheel 28. Each steering wheel sensor 36 is configured independently from other steering wheel sensors 36 to identify a steering command from the driver based on a steering wheel angle (rotational angle) and/or a steering wheel speed of the steering wheel 28 with regard to a reference position.

The steering wheel sensor 36 is shown here as coupled to the steering column 30, because the steering wheel 28 is rigidly coupled to the steering column 30 and a rotation of the steering wheel 28 is consequently converted directly into a rotation of the steering column 30.

In general, the steering wheel sensor 36 can naturally also be coupled to the steering wheel 28 itself, for example to a base component of the steering wheel 28, rather than to the steering column 30. In such examples, the steering wheel sensor 36 can directly detect the rotation of the steering wheel 28 itself.

In accordance with this example, the climate control system 16 of the motor vehicle 10 comprises a climate control circuit 38. The climate control circuit 38 comprises a front radiator 40 and pipe lines 42 in which a climate control medium 44 circulates. The climate control medium 44 is a cooling liquid and, in accordance with this example, water with diverse additives.

The climate control circuit 38 is configured in accordance with this example in such a manner that the climate control medium 44 is applied at least indirectly to the road wheel actuator 22. For this purpose, the climate control circuit 38 is coupled to the road wheel actuator 22.

Furthermore, in accordance with this example, the climate control circuit 38 is additionally coupled to a high-voltage battery 46 of the motor vehicle 10. Accordingly, the climate control medium 44 can be applied to the high-voltage battery 46 and to control its temperature to, for example, cool it or heat it.

In general, the climate control circuit 38 has further components, such as for example pumps, heat exchangers, atomizers, cooling medium reservoirs, valves or the like which are, however, not represented in the example shown in FIG. 1.

Even though the climate control circuit 38 is only configured here in such a manner that it is merely additionally coupled to the high-voltage battery 46, the motor vehicle 10 can nevertheless comprise further climate control circuits or further components to which the climate control circuit 38 can be coupled; for example with respect to a passenger compartment or a drive unit of the motor vehicle 10.

Moreover, the assembly 12 has a temperature controller device 48 with a data processing device 50. The temperature controller device 48 is configured here as a common temperature controller device also with respect to the SBW steering system 14. In general, the temperature controller device 48 can, however, also be separate from the SBW steering system 14 and merely control the functioning of the climate control system 16.

The temperature controller device 48 is coupled in accordance with this example at least indirectly to the road wheel actuator 22, the wheel sensor 26, the steering wheel actuator 32 and the steering wheel sensor 36.

In addition, the assembly 12 has in accordance with this example at least one position signal receiver 52, an environmental sensor 54, a communication device 56, an interior compartment sensor 58, a charge controller 60, a battery management unit 62, an ambient temperature sensor 64 and a road wheel actuator temperature sensor 66, which are all coupled at least indirectly to the temperature controller device 48.

In some examples, the position signal receiver 52 may be used to receive a position signal of a global navigation satellite system, so that the temperature controller device 48 can determine the position of the motor vehicle 10 based on the received position signal.

The environmental sensor 54 can comprise at least one of a camera, a radar, a LiDAR and an infrared sensor. The environmental sensor 54 transmits the data recorded by the environmental sensor data to the temperature controller device 48, which based on the environmental sensor data can determine whether specific objects or persons are located in the environment of the motor vehicle 10.

The temperature controller device 48 can communicate with external components based on the communication device 56. By way of example, based on the communication device 56, the temperature controller device 48 can also recognize external objects, for example a vehicle key of the motor vehicle 10, which can be identified based on NFC (“near field communication”) or Bluetooth.

The interior compartment sensor 58 is configured to record interior compartment data of a passenger compartment of the motor vehicle 10. Accordingly, the temperature controller device 48 may determine whether a driver of the motor vehicle 10 is arranged in the passenger compartment of the motor vehicle 10.

The charge controller 60 controls in general charging processes with respect to the storage devices of the motor vehicle 10, for example with respect to the high-voltage battery 46. The charge controller 60 transmits status information about the ongoing or planned charging processes to the temperature controller device 48 and/or the battery management unit 62.

The battery management unit 62 controls the provision of electrical supply signals within the electrical system of the motor vehicle 10 for the components to be supplied. For example, the battery management unit 62 can transmit information to the temperature controller device 48 with respect to the predominant current flows in the electrical system of the motor vehicle 10.

The ambient temperature sensor 64 is configured to record a temperature of the environment of the motor vehicle 10 and to transmit it to the temperature controller device 48.

The road wheel actuator temperature sensor 66 is coupled to the road wheel actuator 22 and configured to record a temperature of the road wheel actuator 22. The respectively recorded temperature of the road wheel actuator 22 is transmitted to the temperature controller device 48, so that the temperature controller device 48 can initiate relevant control signals to control the temperature of different components of the motor vehicle 10.

The temperature controller device 48 is represented here as part of the assembly 12. In general, the temperature controller device 48 can also assume further control mechanisms of the SBW steering system 14. By way of example, the temperature controller device 48 can also be configured, based on the steering wheel 28 and the steering wheel actuator 32 in the normal operation mode of the SBW steering system 14, to output a torque feedback to the driver of the motor vehicle 10 regarding the lateral control of the motor vehicle 10. To determine the feedback torque to be applied by the steering wheel actuator 32 to the steering column 30 and thus to the steering wheel 28, the temperature controller device 48 then uses data typically recorded by the wheel sensors 26 which are coupled to the road wheels 18 and/or a toothed rack force recorded based on a sensor or determined in some other way. In addition, the temperature controller device 48 can influence the orientation of the steerable road wheels 18 to output a corresponding control signal to the road wheel actuator 22 which ultimately deflects the toothed rack 20 out of the normal position, so that the steerable road wheels 18 are rotated about the vertical vehicle axis. The control signals are defined in such examples by the steering wheel angle of the steering wheel 28 which can be detected using the steering wheel sensor 36.

The assembly 12 and the SBW steering system 14 can naturally also have multiple components of the same type and in general with the same function, for example multiple steering wheel sensors 36, whereby a redundancy is ensured.

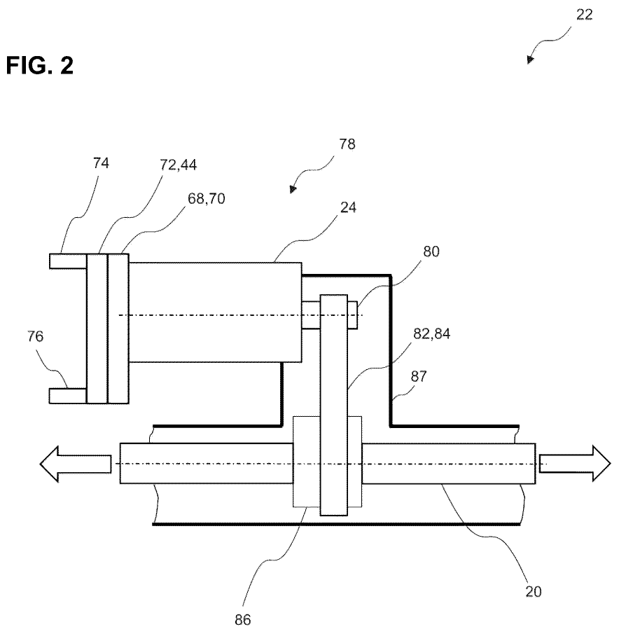

FIG. 2 to FIG. 4 show simplified representations of a road wheel actuator 22 of the assembly 12 in accordance with different examples. In each case, only the differences are mentioned.

The road wheel actuator 22 has a power unit 68 with a converter 70 which is arranged adjacent to the electric motor 24. In accordance with this example (FIG. 2), the road wheel actuator 22 comprises a cooling medium chamber 72 which is arranged directly adjacent to the power unit 68. The climate control medium 44 flows through the cooling medium chamber 72. For this purpose, the cooling medium chamber 72 has an inlet 74 and an outlet 76.

The electric motor 24 and the power unit 68 together form a drive unit 78 of the road wheel actuator 22.

The electric motor 24 is coupled to an output shaft 80, through which a torque generated by the electric motor 24 can be transmitted to a ball nut assembly 86 based on a force transmission unit 82 which has at least one belt drive 84. In some examples, the ball nut assembly 86 can have a deflection device. The torque generated by the electric motor 24 can be used to produce an axial movement of the rack 20 because the ball nut assembly 86 is coupled to the toothed rack 20. As a result, the toothed rack 20 can be deflected from a reference position, which ultimately causes the steerable road wheels 18 to rotate about a vertical vehicle axis.

The cooling medium chamber 72 can also be coupled to a housing 87 of the road wheel actuator 22. In addition, the cooling medium chamber 72 can be formed by cooling medium channels, which are located inside the housing 87 and through which the climate control medium 44 flows.

The direct coupling of the cooling medium chamber 72 to the power unit 68 ensures a very short heat conduction path between the power unit 68 and the cooling medium chamber 72, as well as between the electric motor 24 and the cooling medium chamber 72 (FIG. 2). As a result, the temperature control of the road wheel actuator 22 is particularly efficient with regard to the electric motor 24 in the power unit 68 with the converter 70.

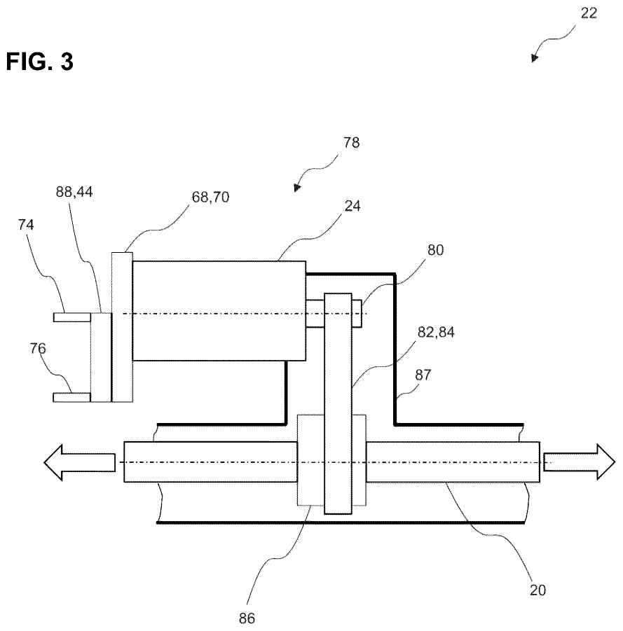

The example shown in FIG. 3 differs from the example shown in FIG. 2 in that, in lieu of a cooling medium chamber 72, a heat exchanger 88 is provided through which the climate control medium 44 flows and which is coupled in such examples in turn to the drive unit 78. For example, the heat exchange 88 is directly coupled to the power unit 68. In a similar manner to the cooling medium chamber 72, the heat exchanger 88 has an inlet 74 and an outlet 76 for the climate control medium 44. This example likewise leads to an efficient coupling of the drive unit 78 because the heat conduction path from the electric motor 24 and the power unit 68 to the heat exchanger 88 is short.

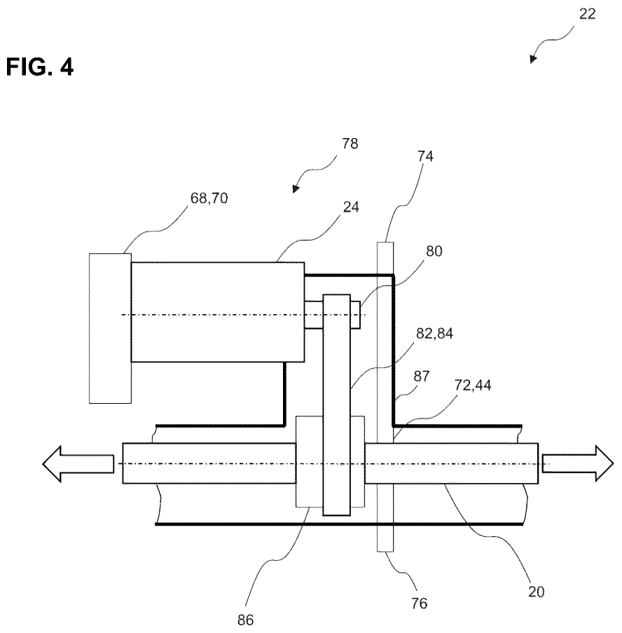

The example shown in FIG. 4 differs from the examples shown in FIG. 2 and FIG. 3 in that the cooling medium chamber 72 is coupled to a housing 87 of the road wheel actuator 22 in the region of the force transmission unit 82. As a result, in some examples, a short and efficient heat conduction path may be created with respect to the force transmission unit 82, the belt drive 84 and the ball nut unit 86. Examples disclosed herein may be used to implement indirect heating of the components of the force transmission unit 82 based on the climate control medium 44 because, for example, the belt drive 84 typically has a synthetic material-based material or an elastomer.

The climate control medium 44 can naturally also cause the relevant components to be heated up, as needed. Whether cooling or heating is effected by the climate control medium 44 depends on the temperature of the climate control medium 44 within the climate control circuit 38 relative to the temperature of the road wheel actuator 22.

The different coupling modes of the climate control circuit 38 to the road wheel actuator 22 are shown individually according to the different examples in FIGS. 2 to 4. Naturally, examples disclosed herein may be used to provide multiple couplings of the climate control circuit 38 to the road wheel actuator 22, in which different combinations of the coupling modes of the illustrated examples can be combined with one another.

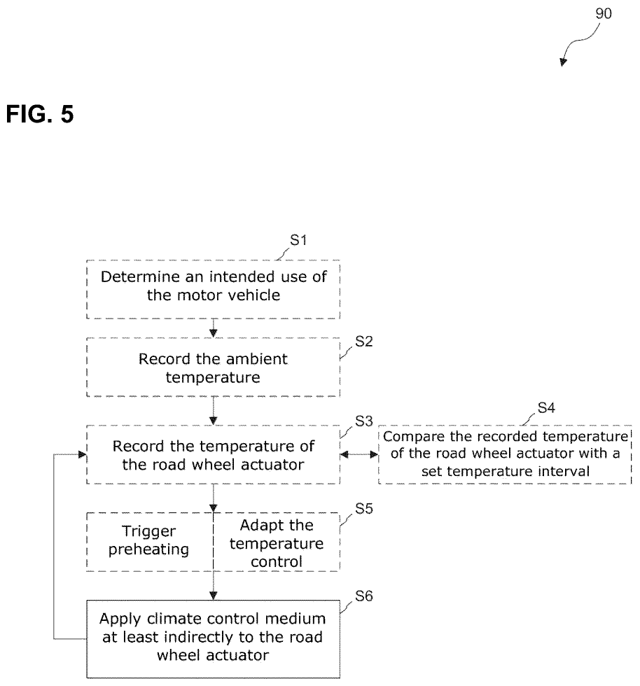

FIG. 5 shows a simplified schematic representation of a method 90 for operating an assembly 12 for a powered motor vehicle 10 in accordance with one example. Optional operations are illustrated in a dashed manner.

The method 90 initially comprises the example operation S1 in which the temperature controller device 48 determines an intended use of the motor vehicle 10 by a vehicle user. For this purpose, the temperature controller device 48 can use, for example, the position signal receiver 52, the environmental sensor 54, the communication device 56, the interior compartment sensor 58, the charge controller 60 and the battery management unit 62. In some examples, the components mentioned may be used to determine that the vehicle user would like to use the motor vehicle 10 soon. For example, the communication device 56 may be used to detect that the vehicle key of the motor vehicle 10 is approaching the motor vehicle 10. In addition, the entry of the driver into the motor vehicle 10 may be detected, for example based on the interior compartment sensor 58. The charge controller 60 and/or the battery management unit 62 can indicate that the high-voltage battery 46 of the motor vehicle 10 is currently being charged which is an indication that the motor vehicle 10 is soon to be used. In addition, the battery management unit 62 can indicate that the high-voltage battery 46 is preheated, which likewise indicates that the motor vehicle 10 is soon to be used. The position signal receiver 52 can be used, for example, to determine the position of the motor vehicle 10. In view of a possible route intended by a driver of motor vehicle 10, it can then be determined that the motor vehicle 10 is to be used to reach the destination of the route.

In the following example operation S2, the ambient temperature of motor vehicle 10 is recorded. For example, for this purpose, the ambient temperature sensor 64 may be used to transmit the accordingly recorded ambient temperature to the temperature controller device 48.

Subsequently, the method 90 comprises the example operation S3, in which a temperature of the road wheel actuator 22 is recorded. For this purpose, the temperature controller device 48 can make use of the road wheel actuator temperature sensor 66.

Information regarding a set temperature range for the road wheel actuator 22 can be stored within the temperature controller device 48 or in a storage device connected thereto. The temperature of the road wheel actuator 22 recorded in operation S3 can then be compared with the set temperature interval for the road wheel actuator 22 according to the example operation S4 as a development of the example operation S3.

On the basis of the information recorded and determined in this manner, the temperature controller device 48 can then trigger a preheating of the road wheel actuator 22 according to the example operation S5. By way of example, the ambient temperature in the region of the motor vehicle 10 can be so low that the synthetic material-based or elastomer-based components of the road wheel actuator 22 would suffer were they to be used immediately (without preheating). This can justify triggering preheating of the road wheel actuator 22.

The temperature controller device 48 then controls the climate control system 16 in such a way that the road wheel actuator 22 is at least indirectly supplied with the climate control medium 44 in accordance with operation S6 of method 90. For example, components of the force transmission unit 82 of the road wheel actuator 22 can be heated, which helps to prevent brittleness and a resulting unexpected operating condition. In addition, a heated road wheel actuator 22 offers increased control precision in cold ambient temperatures due to lower mechanical friction resulting from the temperature increase, more precise straight-line running, and more accurate estimation of the toothed rack force, which is taken into account when determining the feedback torque for the driver at the steering wheel 28.

The method 90 subsequently includes returning to the example operation S3, in which the temperature controller device 48 uses the road wheel actuator temperature sensor 66 to check the temperature of the road wheel actuator 22. In some examples, the temperature of the road wheel actuator 22 can also be estimated using temperature models. In some examples, according to the example operation S4, the temperature of the road wheel actuator 22 can also be compared with the set temperature interval.

As a result, in the subsequent example operation S5, the temperature controller device 48 can trigger an adaptation of the temperature control to adjust the temperature control of the road wheel actuator 22 by applying the climate control medium 44 as required. For this purpose, the temperature controller device 48 can, for example, influence other components of the climate control system 16, for example to control the flow rate of the climate control medium 44. This also provides the opportunity to use the climate control medium 44 in such a manner that the road wheel actuator 22 is cooled, for example when the road wheel actuator 22 generates a relatively high amount of heat due to a demand for high performance. This provides, for example, the opportunity to cool the components of the road wheel actuator 22 in which the majority of the generated heat is generated in a high performance state. These are the electric motor 24 and the power unit 68.

Example instructions and/or operations of FIG. 5 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices /d/ or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

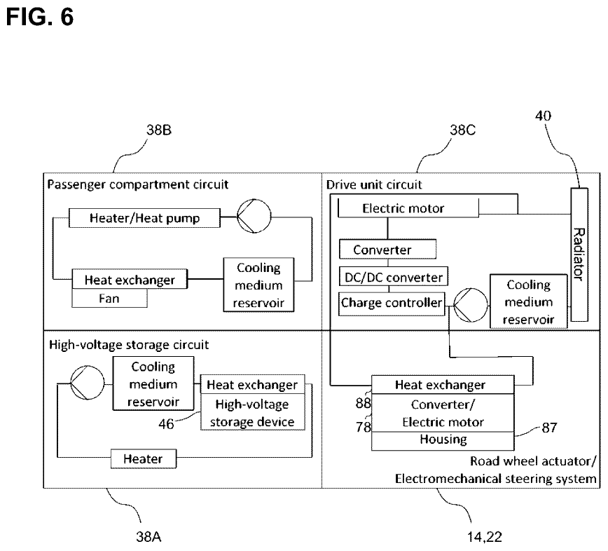

FIG. 6 to FIG. 11 show simplified schematic representations of the assembly 12 in accordance with different examples. In each case, only the differences are mentioned. The figures show here in each case the climate control circuits 38 of the climate control system 16 in accordance with different examples of the assembly 12.

The climate control system 16 comprises in accordance with the examples illustrated here three different climate control circuits 38A, 38B, 38C. A first climate control circuit 38A relates to a circulating climate control medium 44 for controlling the temperature of the high-voltage battery 46.

A second climate control circuit 38B is configured to control the temperature of a passenger compartment of the motor vehicle 10.

A third climate control circuit 38C is configured to control the temperature of the drive unit of the motor vehicle 10, such as the converter and the electric motor to drive the motor vehicle 10.

The front radiator 40 is shown here as part of the climate control circuit 38C relating to the drive unit of the motor vehicle 10. The climate control circuits 38A, 38B, 38C can, however, also diverge from the present examples, for example in that the front radiator 40 can also be part of other climate control circuits 38A, 38B, 38C.

In a further example, the climate control circuits 38A, 38B, 38C can also be coupled to one another.

With respect to the road wheel actuator 22 of the SBW steering system 14, only examples of the coupling to the climate control system 16 are represented here.

In accordance with the example shown in FIG. 6, a heat exchanger 88 is coupled to the road wheel actuator 22 and connected to the climate control circuit 38C of the drive unit of the motor vehicle 10. The climate control medium 44 therefore flows through the heat exchanger 88. Accordingly, the temperature of the road wheel actuator 22 may be controlled.

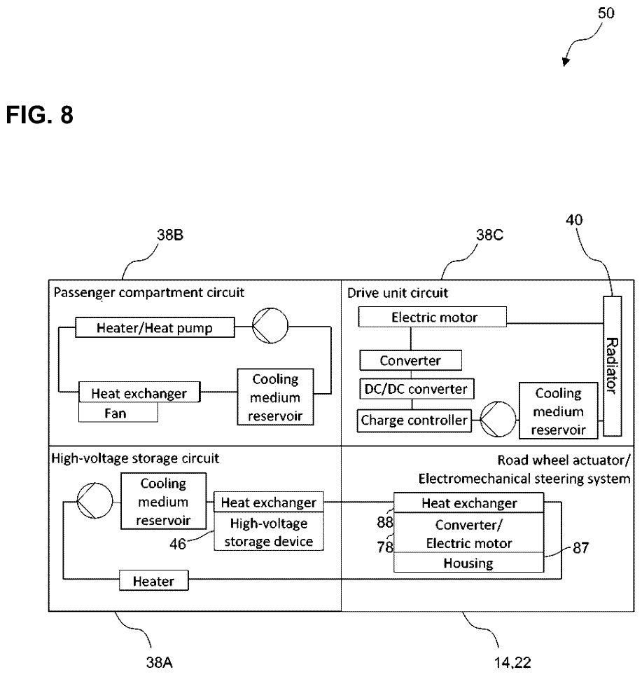

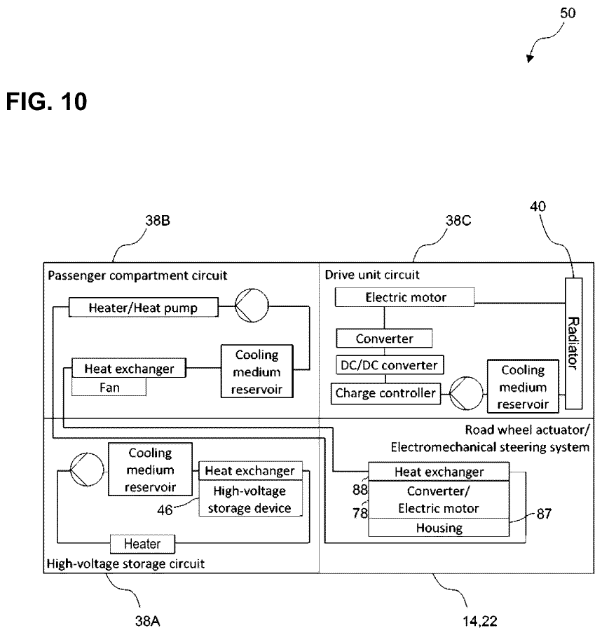

In alternative examples, the heat exchanger 88 of the road wheel actuator 22 can also be coupled to the climate control circuit 38A which is provided for the high-voltage battery 46 (FIG. 8) or to the climate control circuit 38B which is provided for the passenger compartment of the motor vehicle 10 (FIG. 10).

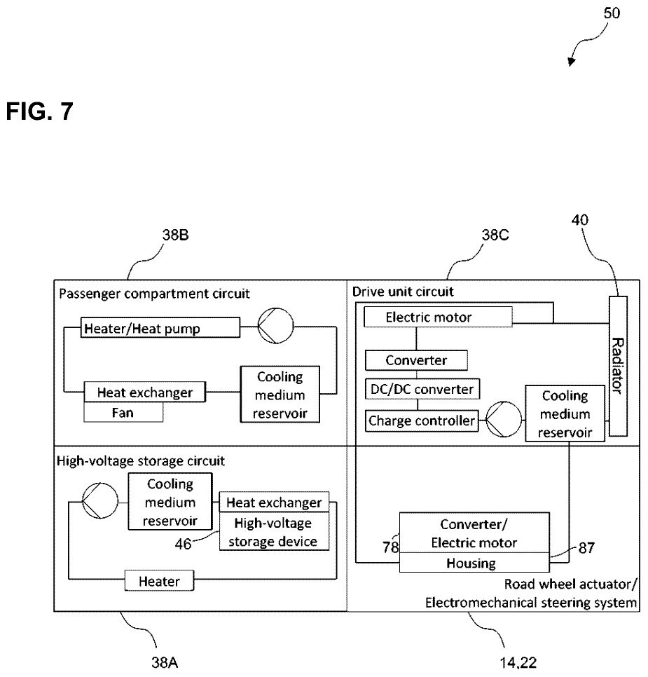

Alternatively thereto, the climate control circuit 38C relating to the drive unit of the motor vehicle 10 can also be coupled to the housing 87 of the road wheel actuator 22 (FIG. 7). In such examples, the heat exchanger 88 can be omitted.

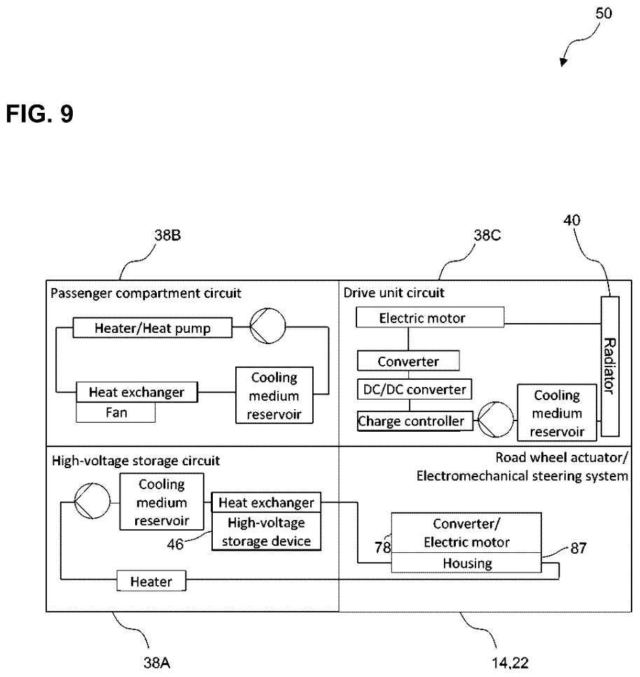

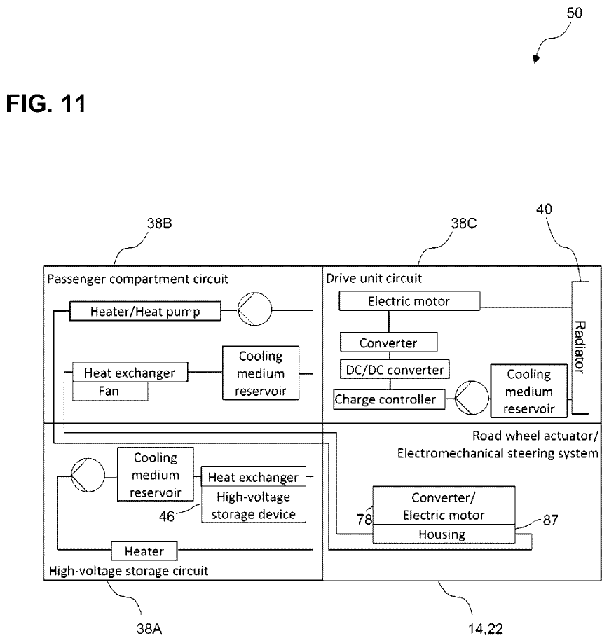

In alternative examples, the housing 87 of the road wheel actuator 22 can also be coupled to the climate control circuit 38A which is provided for the high-voltage battery 46 (FIG. 9) or to the climate control circuit 38B which is provided for the passenger compartment of the motor vehicle 10 (FIG. 11).

In a further example, not illustrated, the climate control circuit 38C relating to the drive unit of the motor vehicle 10 can also be coupled to the power unit 78 of the road wheel actuator 22, in accordance with the example shown in FIG. 2 and FIG. 3.

The assembly 12 and the method 90 may be used to control the temperature of the road wheel actuator 22 in a reliably precise manner so that the temperature of the road wheel actuator 22 can be maintained constant in accordance with a predetermined set temperature interval. Accordingly, examples disclosed herein may be used to prevent unexpected operating conditions with respect to the road wheel actuator 22 due to extreme temperatures, for example low temperatures or high temperatures in the case of high performance requirements. In addition, the power output of the road wheel actuator 22 is more uniform. For example, it is not necessary to reduce a power output of the road wheel actuator 22 in cases of high temperature. This also simplifies coordination within the SBW steering system 14 compared to previous approaches.

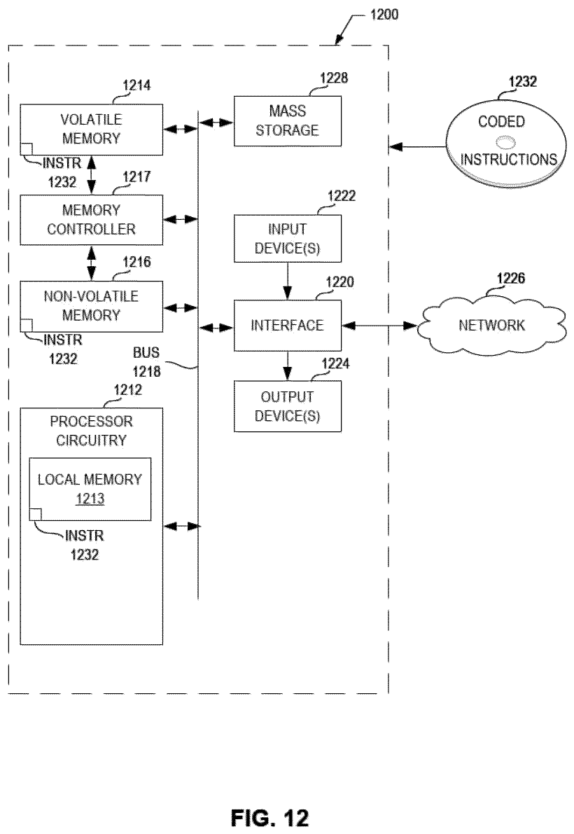

FIG. 12 is a block diagram of an example programmable circuitry platform 1200 structured to execute and/or instantiate the example machine-readable instructions and/or the example operations of FIG. 5 to implement examples disclosed herein. The programmable circuitry platform 1200 can be, for example, a control device, an electronic control unit (ECU), a self-learning machine (e.g., a neural network), or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 1212 may be implemented by one or more semiconductor based (e.g., silicon based) devices.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a button, a touchscreen, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 1232, which may be implemented by the machine-readable instructions of FIG. 5, may be stored in the mass storage device 1228, in the volatile memory 1214, in the non-volatile memory 1216, and/or on at least one non-transitory computer readable storage medium such as a CD or DVD which may be removable.

Specific examples disclosed herein use circuits (for example one or more circuits) to implement standards, protocols, methods, or technologies disclosed herein, to functionally couple two or more components, to generate information, to process information, to analyze information, to generate signals, to encode/decode signals, to convert signals, to transmit and/or receive signals, to control other devices, etc. Circuits of any type may be used.

In some examples, a circuit such as the temperature controller device comprises, among other things, one or more data processing devices, such as a processor (for example, a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics or combinations thereof. In some examples, the circuit includes hardware circuit implementations (for example, implementations in analog circuits, implementations in digital circuits, and the like, and combinations thereof).

In some examples, circuits comprise combinations of circuits and computer program products with software or firmware instructions stored on one or more computer-readable storage media, which interact to cause a device to perform one or more of the protocols, methods, or technologies described herein. In some examples, the circuitry comprises circuits, such as, for example, microprocessors or parts of microprocessors, which require software, firmware, and the like to operate. In some examples, the circuits comprise one or more processors or parts thereof and the associated software, firmware, hardware, and the like.

This disclosure may refer to quantities and numbers. Unless expressly stated, such quantities and numbers are not to be considered limiting, but rather examples of the possible quantities or numbers in connection with the disclosure. In this context, the term “plural” may also be used in the disclosure to refer to a quantity or number. In this context, the term “plurality” means any number greater than one, for example, two, three, four, five, etc. The terms “about,” “approximately,” “close to,” etc. mean plus or minus 5% of the specified value.

Although the disclosure has been presented and described with reference to one or more examples, those skilled in the art will be able to make equivalent changes and modifications after reading and understanding this description and the accompanying drawings.

1. An assembly to be installed in a vehicle, the assembly comprising:
a climate control system having a climate control circuit; and
a steer-by-wire steering system having a road wheel actuator, wherein:
a climate control medium circulates in the climate control circuit;
the steer-by-wire steering system is coupled to the climate control system; and
the climate control medium is applied at least indirectly to the road wheel actuator to cool and heat the road wheel actuator.

2. The assembly of claim 1, wherein the road wheel actuator has an integrated cooling medium chamber through which the climate control medium is to flow.

3. The assembly of claim 2, wherein the integrated cooling medium chamber is coupled to a drive unit of the road wheel actuator.

4. The assembly of claim 1, wherein the road wheel actuator includes a heat exchanger, the heat exchanger coupled at least indirectly to an electric motor and to a converter of the road wheel actuator and through which the climate control medium is to flow.

5. The assembly of claim 1, including a temperature controller device, wherein the temperature controller device is configured to trigger an at least indirect application of the climate control medium to the road wheel actuator.

6. The assembly of claim 5, including:
a temperature sensor coupled to the road wheel actuator; and
an ambient temperature sensor, wherein:
the temperature controller device is to trigger the at least indirect application of the climate control medium to the road wheel actuator at least also based on a temperature of the road wheel actuator recorded based on the temperature sensor and an ambient temperature recorded based on the ambient temperature sensor.

7. The assembly of claim 6, wherein the temperature controller device is configured to trigger the at least indirect application of the climate control medium to the road wheel actuator to perform preheating for an intended use of the vehicle.

8. The assembly of claim 7, wherein the temperature controller device is to trigger the at least indirect application of the climate control medium to the road wheel actuator to perform preheating based on detection of a key approaching the vehicle.

9. A method to operate an assembly of a vehicle, the method comprising:
circulating a climate control medium in a climate control circuit of a climate control system corresponding to a steer-by-wire system of the assembly; and
applying the climate control medium at least indirectly to a road wheel actuator of the climate control system to cool and heat the road wheel actuator.

10. The method of claim 9, including circulating the climate control medium through an integrated cooling medium chamber of the road wheel actuator.

11. The method of claim 10, wherein the integrated cooling medium chamber is coupled to a drive unit of the road wheel actuator.

12. The method of claim 9, including circulating the climate control medium through a heat exchanger of the road wheel actuator, the heat exchanger coupled at least indirectly to an electric motor and to a converter of the road wheel actuator.

13. The method of claim 9, including triggering an application of the climate control medium to the road wheel actuator to perform preheating for an intended use of the vehicle.

14. The method of claim 13, wherein the triggering of the application of the climate control medium to the road wheel actuator to perform the preheating is based on detection of a driver entering the vehicle.

15. A motor vehicle comprising:
a climate control system having a climate control circuit;
a steer-by-wire system having a road wheel actuator, the steer-by-wire system coupled to the climate control system; and
a climate control medium to circulate in the climate control circuit to cool and heat the road wheel actuator.

16. The motor vehicle of claim 15, wherein the road wheel actuator has an integrated cooling medium chamber coupled to a drive unit of the road wheel actuator, the integrated cooling medium chamber to receive the climate control medium.

17. The motor vehicle of claim 15, wherein the climate control circuit comprises at least one of a high-voltage storage circuit, a passenger compartment circuit or a drive unit circuit of the motor vehicle.

18. The motor vehicle of claim 15, including:
a temperature sensor coupled to the road wheel actuator;
an ambient temperature sensor; and
a temperature controller device to trigger application of the climate control medium to the road wheel actuator at least also based on a temperature of the road wheel actuator recorded based on the temperature sensor and an ambient temperature recorded based on the ambient temperature sensor.

19. The motor vehicle of claim 15, including a temperature controller device to trigger application of the climate control medium to the road wheel actuator to perform preheating for an intended use of the motor vehicle.

20. The motor vehicle of claim 19, wherein the temperature controller device is to trigger the application of the climate control medium to the road wheel actuator to perform the preheating based on detection of a key approaching the motor vehicle.
